(19) United States
(12) Patent Application Publication
(10) Pub. No.: US 2024/0393998 A1
(43) Pub. Date: Nov. 28, 2024

(54) BOOTH APPARATUS

(71) Applicant: FUJIFILM Business Innovation Corp., Tokyo (JP)

(72) Inventors: Tsutomu SHIIHARA, Kanagawa (JP); Masatoshi DEGUCHI, Kanagawa (JP); Hideaki SUGIMOTO, Kanagawa (JP); Shoko MATSUNAGA, Kanagawa (JP)

(73) Assignee: FUJIFILM Business Innovation Corp., Tokyo (JP)

(21) Appl. No.: 18/502,072

(22) Filed: Nov. 5, 2023

(30) Foreign Application Priority Data
May 26, 2023 (JP) 2023-086947

(51) Int. Cl. G06F 3/14; G06F 3/04883

(52) U.S. Cl. CPC G06F 3/1423; G06F 3/04883

(57) ABSTRACT

A booth apparatus includes a space forming member that includes a first surface, a second surface, and a third surface and that forms a space surrounded by the first surface, the second surface, and the third surface, an electronic blackboard that is provided on any of the first surface, the second surface, or the third surface in the space, and a projecting device that projects an image onto at least one surface out of the first surface, the second surface, or the third surface on which the electronic blackboard is not provided.

### CROSS-REFERENCE TO RELATED APPLICATIONS

This application is based on and claims priority under 35 USC 119 from Japanese Patent Application No. 2023-086947 filed May 26, 2023.

### BACKGROUND

### (i) Technical Field

The present invention relates to a booth apparatus.

### (ii) Related Art

A work space in a private room where a desk or a display is installed is known.

Described in JP2020-167614A are remote communication devices that acquire spatial images of distant points at respective points and each of which displays, at each point, a spatial image of another point.

Described in <URL: https://www.prism.ricoh/shiro/> is displaying, on a wall surface, an image stored in a personal computer or a smartphone.

### SUMMARY

Meanwhile, the desk or the display is simply placed in the work space of the private room in the related art. Therefore, it cannot be said that the work space in the related art is a space where one person and another can work together easily.

Aspects of non-limiting embodiments of the present disclosure relate to a booth apparatus that provides an environment, in which a person can easily work together with another person in comparison with a work space in which a desk or a display is simply placed, for a person who uses the environment.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a booth apparatus including a space forming member that includes a first surface, a second surface, and a third surface and that forms a space surrounded by the first surface, the second surface, and the third surface, an electronic blackboard that is provided on any of the first surface, the second surface, or the third surface in the space, and a projecting device that projects an image onto at least one surface out of the first surface, the second surface, or the third surface on which the electronic blackboard is not provided.

### BRIEF DESCRIPTION OF THE DRAWINGS

Exemplary embodiment(s) of the present invention will be described in detail based on the following figures, wherein:

FIG. 1 is a perspective view showing a booth apparatus;

FIG. 2 is a view of the booth apparatus as seen from a front side;

FIG. 3 is a view of the booth apparatus as seen from an upper side;

FIG. 4 is a view showing a projecting device;

FIG. 5 is a view showing a projecting device;

FIG. 6 is a view showing another example of a space forming member;

FIG. 7 is a perspective view showing a booth apparatus according to a modification example;

FIG. 8 is a block diagram showing a system including a control device;

FIG. 9 is a view showing a third surface;

FIG. 10 is a view showing the third surface;

FIG. 11 is a view showing a first surface;

FIG. 12 is a view showing the third surface;

FIG. 13 is a perspective view showing two booth apparatuses;

FIG. 14 is a view showing the third surface;

FIG. 15 is a view showing the third surface;

FIG. 16 is a view showing the third surface;

FIG. 17 is a view showing the third surface;

FIG. 18 is a view showing the third surface;

FIG. 19 is a view showing the third surface;

FIG. 20 is a block diagram showing a configuration of an entire system according to a second exemplary embodiment;

FIG. 21 is a diagram showing an account management table;

FIG. 22 is a flowchart illustrating the flow of processing according to the second exemplary embodiment;

FIG. 23 is a view showing the third surface; and

FIG. 24 is a view showing the third surface.

### DETAILED DESCRIPTION

### First Exemplary Embodiment

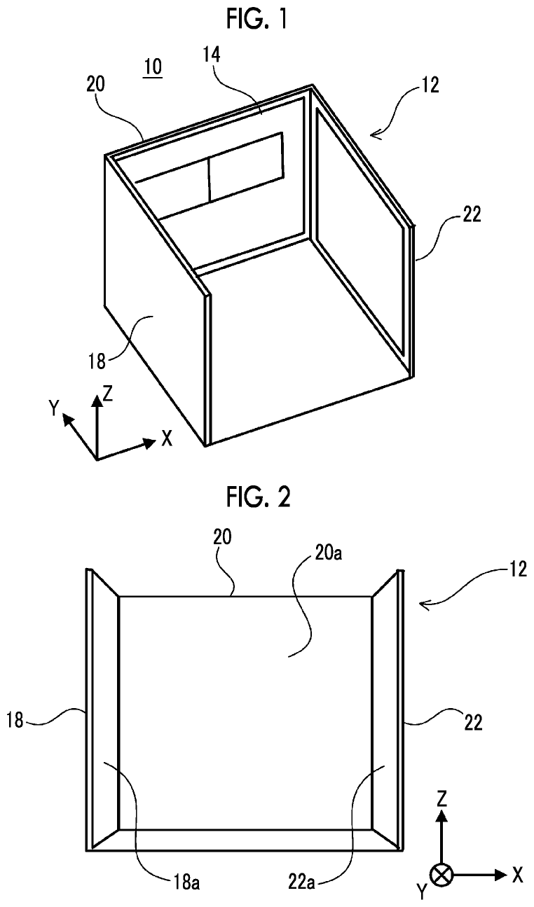

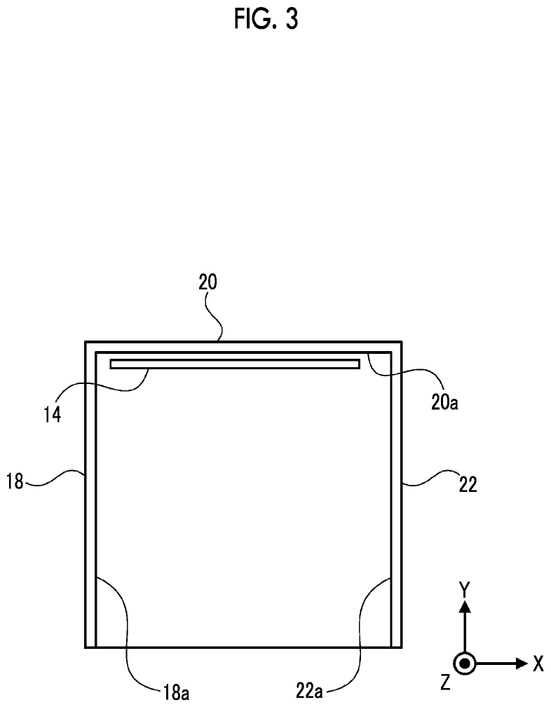

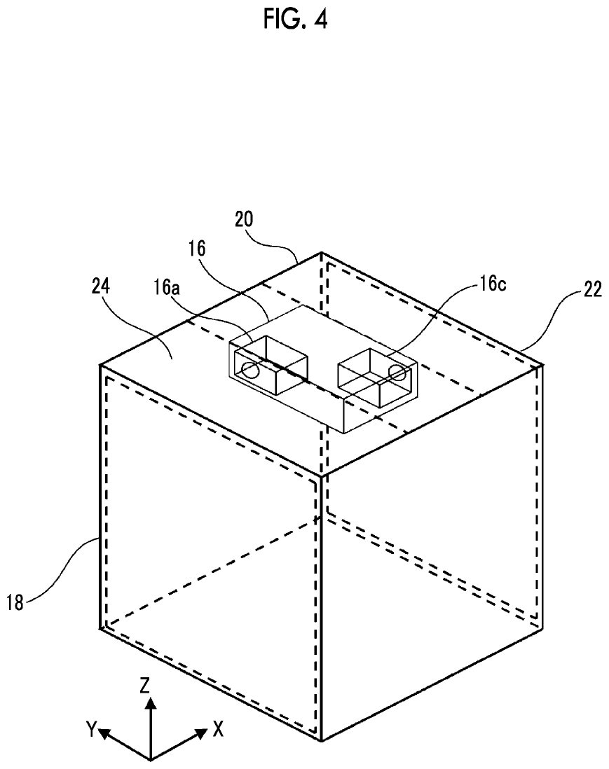

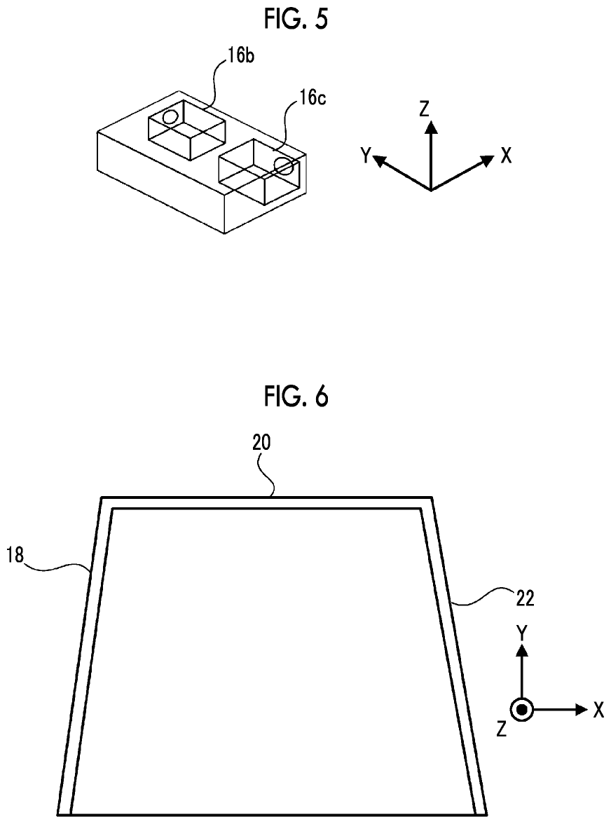

A booth apparatus according to an exemplary embodiment will be described with reference to FIGS. 1 to 5. FIG. 1 is a perspective view showing a booth apparatus 10 according to the exemplary embodiment. FIG. 2 is a view of the booth apparatus 10 as seen from a front side. FIG. 3 is a view of the booth apparatus 10 as seen from an upper side. FIGS. 4 and 5 are views showing a projecting device. In FIGS. 1 to 5, a three-dimensional orthogonal coordinate system consisting of an X-axis, a Y-axis, and a Z-axis that are orthogonal to one another is defined.

The booth apparatus 10 includes a space forming member 12, an electronic blackboard 14, and a projecting device 16. The booth apparatus 10 may be installed indoors or may be installed outdoors.

The space forming member 12 forms a space surrounded by at least three surfaces. For example, as shown in FIGS. 1 to 3, the space forming member 12 includes a first side wall 18, a second side wall 20, and a third side wall 22. The first side wall 18 forms a first surface 18a in the booth apparatus 10. The second side wall 20 forms a second surface 20a in the booth apparatus 10.

The third side wall 22 forms a third surface 22a in the booth apparatus 10. A space surrounded by the first side wall 18, the second side wall 20, and the third side wall 22 is formed inside the space forming member 12. The first surface 18a, the second surface 20a, and the third surface 22a are surfaces formed in the space surrounded by the first side wall 18, the second side wall 20, and the third side wall 22 (that is, inner surfaces).

As shown in FIG. 4, the space forming member 12 includes a ceiling 24. For the sake of convenience of description, the ceiling 24 is not shown in FIGS. 1 to 3. The space forming member 12 may include a floor or may not include a floor.

For example, the first side wall 18, the second side wall 20, the third side wall 22, and the ceiling 24 are connected to each other by connection members such as bolts, nuts, and hinges. It is a matter of course that all or part of the first side wall 18, the second side wall 20, the third side wall 22, and the ceiling 24 may be integrated members. All or part of the first side wall 18, the second side wall 20, and the third side wall 22 may be provided to be separated from each other while being supported by a support member such as a stand, without being connected to each other or integrated with each other.

As shown in FIG. 4, the projecting device 16 is provided on the ceiling 24. The space forming member 12 may not include the ceiling 24. In this case, the projecting device 16 is suspended from a ceiling that does not constitute the booth apparatus 10 or is supported by a support member such as a stand.

The second side wall 20 is provided to intersect the first side wall 18 beside the first side wall 18. Accordingly, the second surface 20a intersects the first surface 18a beside the first surface 18a. The third side wall 22 is provided to face the first side wall 18 beside the second side wall 20 and to intersect the second side wall 20. Accordingly, the third surface 22a faces the first surface 18a beside the second surface 20a and intersects the second surface 20a.

The sizes (for example, the vertical widths and the horizontal widths) and the shapes of the first surface 18a, the second surface 20a, and the third surface 22a may be the same as each other or may be different from each other. Each surface may have a rectangular shape or a curved shape.

The electronic blackboard 14 is a device that receives input of information (for example, handwritten text or a figure) and that displays an image. For example, the electronic blackboard 14 is a device that includes a display, that electronically converts text, a figure, or the like that is drawn on a surface of the display by a finger, a stylus pen, or the like, and that displays the text, the figure, or the like converted in such a manner on the display. Information electronically converted may be stored in a memory included in the electronic blackboard 14, may be stored in an external memory, may be output to an external device (for example, a terminal device, a server, or other devices), or may be printed by a printer. In addition, the electronic blackboard 14 may receive information such as an image or a text string from an external memory or an external device and display the information on the display. The electronic blackboard 14 may include one display or a plurality of displays. One display may be provided on one surface of the booth apparatus 10 or a plurality of displays may be provided on one surface of the booth apparatus 10.

The electronic blackboard 14 is provided on any of the first surface 18a, the second surface 20a, or the third surface 22a. The electronic blackboard 14 may be attached to any of the first surface 18a, the second surface 20a, or the third surface 22a, may be leaned against any of the first surface 18a, the second surface 20a, or the third surface 22a, or may be provided in front of any of the first surface 18a, the second surface 20a, or the third surface 22a with a gap provided therebetween.

The projecting device 16 is, for example, a projector, and projects an image onto at least one surface of the first surface 18a, the second surface 20a, or the third surface 22a on which the electronic blackboard 14 is not provided. Accordingly, the image is displayed on the at least one surface. The image may be a still image or may be a moving image. The data format of the image is not particularly limited, and a document, text, or the like may be included in the category of the image. A speaker may be provided inside or outside the space forming member 12 to emit sound. For example, a sound may be emitted from the speaker as an image is displayed.

In an example shown in FIGS. 1 to 3, the electronic blackboard 14 is provided on the second surface 20a and the projecting device 16 projects an image onto at least one surface of the first surface 18a or the third surface 22a.

As shown in FIG. 4, the projecting device 16 includes projectors 16a and 16c. A projection lens of the projector 16a is provided to face the first surface 18a, and the projector 16a projects an image onto the first surface 18a. A projection lens of the projector 16c is provided to face the third surface 22a, and the projector 16c projects an image onto the third surface 22a. The projecting device 16 may project an image onto the first surface 18a by means of the projector 16a and project an image onto the third surface 22a by means of the projector 16c or may project an image onto any one surface out of the first surface 18a or the third surface 22a.

FIG. 5 shows another example of the projecting device 16. The projecting device 16 shown in FIG. 5 includes a projector 16b and the projector 16c. A projection lens of the projector 16b is provided to face the second surface 20a, and the projector 16b projects an image onto the second surface 20a. For example, in a case where an image is to be projected onto the second surface 20a and the third surface 22a, the projecting device 16 shown in FIG. 5 is used.

The configuration of the projecting device 16 shown in FIGS. 4 and 5 is merely an example. The projecting device 16 may include at least one of the projector 16a, the projector 16b, or the projector 16c and project an image onto at least one surface. In addition, a microphone or a speaker may be provided in the projecting device 16 or may be provided in the vicinity of the projecting device 16.

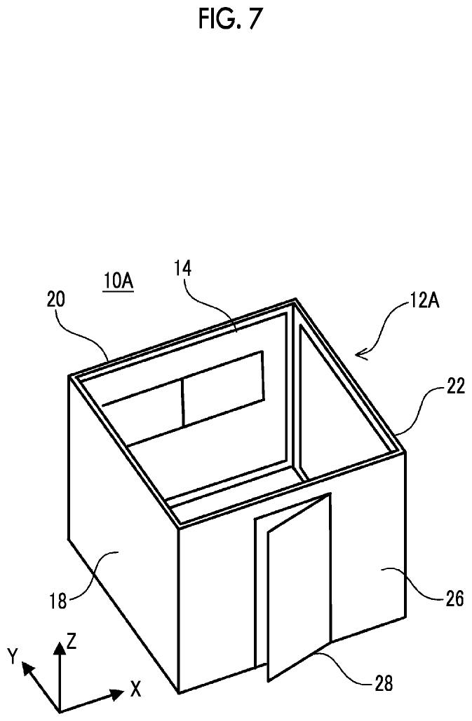

In the example shown in FIGS. 1 to 3, an angle (will be referred to as an angle α for the sake of convenience) formed between the first side wall 18 and the second side wall 20 and an angle (will be referred to as an angle β for the sake of convenience) formed between the second side wall 20 and the third side wall 22 are 90° or are angles close to 90°. However, such angles are merely examples. The angles α and β may be angles that are not 90°. FIG. 6 shows an example of such a case. FIG. 6 is a view showing another example of the space forming member 12, and is a view of the space forming member 12 as seen from above. In the example shown in FIG. 6, the angles α and β are angles larger than 90°. It is a matter of course that the angles α and β may be angles smaller than 90°. The angle α and the angle β may be the same as each other or may be different from each other. Note that the first side wall 18, the second side wall 20, and the third side wall 22 may be connected to each other to be foldable so that the angles α and β are changed depending on the way of use selected by an user.

FIG. 7 shows a booth apparatus 10A according to a modification example. FIG. 7 is a perspective view showing the booth apparatus 10A. The booth apparatus 10A includes a space forming member 12A instead of the space forming member 12. The space forming member 12A includes the first side wall 18, the second side wall 20, and the third side wall 22 as with the space forming member 12 and further includes a fourth side wall 26. The fourth side wall 26 is disposed to face the second side wall 20. For example, a closed space is formed by the first side wall 18, the second side wall 20, the third side wall 22, and the fourth side wall 26. Although the ceiling 24 is not shown in FIG. 7, the space forming member 12A includes the ceiling 24 as in the case of the booth apparatus 10, and the projecting device 16 is provided on the ceiling 24. It is a matter of course that the space forming member 12A may not include the ceiling 24. In this case, the projecting device 16 is suspended from a ceiling that does not constitute the booth apparatus 10A or is supported by a support member such as a stand. The space forming member 12A may include a floor or may not include a floor.

The fourth side wall 26 is provided with a door 28. The user of the booth apparatus 10A can open the door 28 to enter the booth apparatus 10A (that is, the space surrounded by the first side wall 18, the second side wall 20, the third side wall 22, and the fourth side wall 26) from the outside of the booth apparatus 10A and to exit the booth apparatus 10A from the inside of the booth apparatus 10A. The door 28 may be provided with an electronic lock so that the door 28 is locked by the electronic lock. For example, the electronic lock is unlocked and the user is allowed to enter the booth apparatus 10A in a case where user authentication is successful.

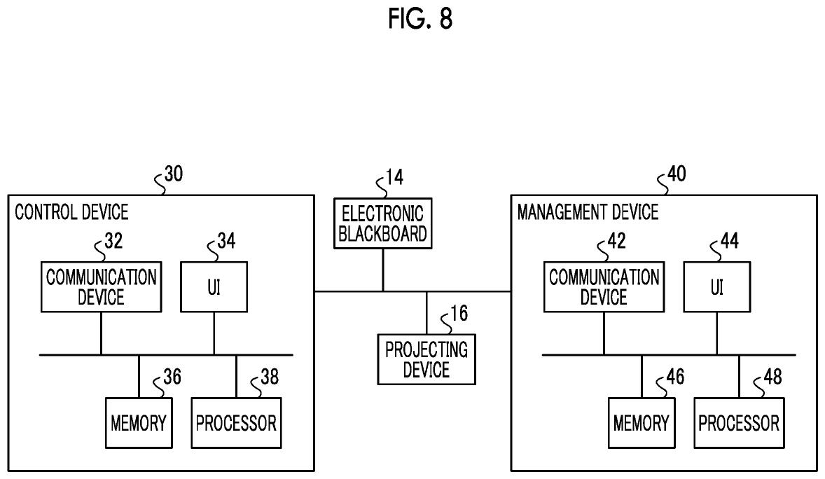

A control device 30 will be described with reference to FIG. 8. FIG. 8 is a block diagram showing the control device 30. The control device 30 controls the booth apparatus 10 or the booth apparatus 10A. The control device 30 may be provided in a space surrounded by the space forming member 12, or may be provided outside such a space. The same applies to the space forming member 12A.

The control device 30 includes a communication device 32, a UI 34, a memory 36, and a processor 38.

The communication device 32 includes one or more communication interfaces including, for example, a communication chip and a communication circuit and has a function of transmitting information to other devices and a function of receiving information from other devices. The communication device 32 may have a wireless communication function such as Wi-Fi (registered trademark), or may have a wired communication function. The communication device 32 may have a short-range wireless communication function. Examples of short-range wireless communication include, for example, Bluetooth (registered trademark) and a radio frequency identifier (RFID).

The UI 34 is a user interface and includes a display and an operation device. The display is a liquid crystal display, an EL display, or the like. The operation device is a keyboard, a mouse, an input key, an operation panel, or the like. The UI 34 may be a UI such as a touch panel including both a display and an input device. In addition, the UI 34 may include a microphone or a speaker. For example, the UI 34 may be provided in the space surrounded by the space forming member 12, or may be provided outside such a space. The same applies to the space forming member 12A.

The memory 36 is a device that constitutes one or more storage areas for storage of data. Examples of the memory 36 include a hard disk drive (HDD), a solid state drive (SSD), various memories (for example, RAM, DRAM, NVRAM, ROM, and the like), another storage device (for example, an optical disk or the like), and a combination thereof.

The processor 38 controls the operation of each part of the booth apparatus 10 or the booth apparatus 10A. For example, the processor 38 controls image projection performed by the projecting device 16. The processor 38 may control the electronic blackboard 14. It is a matter of course that the electronic blackboard 14 itself may include a processor so that the electronic blackboard 14 is controlled by the processor that the electronic blackboard 14 includes.

For example, the processor 38 may receive an image from an external device via a communication path such as the Internet or a local area network (LAN) and cause the projecting device 16 to project the image. The external device is a terminal device, an image server, a document management system, a cloud server, another booth apparatus 10, or the like. The processor 38 may cause the projecting device 16 to project an image stored in the memory 36. A terminal device (for example, a smartphone, a personal computer (hereinafter referred to as a “PC”), or a tablet PC) of the user may be connected to the control device 30 and the processor 38 acquires, from the terminal device, an image stored in the terminal device. For example, in a case where the user operates the UI 34 or an UI of the terminal device to select an image to be projected, the processor 38 causes the projecting device 16 to project the selected image.

In addition, in a case where the user operates the UI 34 or an UI of the terminal device to designate a surface onto which an image is to be projected, the processor 38 controls the projecting device 16 such that an image is projected onto the surface designated by the user. The surface onto which the image is to be projected may be determined in advance.

The processor 38 may cause the projecting device 16 to project information input to the electronic blackboard 14 or an image displayed on the electronic blackboard 14. Accordingly, the information input to the electronic blackboard 14 or the image displayed on the electronic blackboard 14 is projected onto and displayed on at least one surface out of the first surface 18a, the second surface 20a, or the third surface 22a.

The processor 38 may transmit the information input to the electronic blackboard 14 or the image displayed on the electronic blackboard 14 to a device other than the booth apparatus 10 via a communication path such as the Internet or a LAN or may cause the memory 36 to store the information or the image. In addition, the processor 38 may receive information to be displayed on the electronic blackboard 14 and cause the electronic blackboard 14 to display the information.

In a case where the booth apparatus 10A is used, the processor 38 may control the electronic lock provided for the door 28 of the booth apparatus 10A. For example, the processor 38 locks the electronic lock in a case where an instruction to lock the electronic lock is received and unlocks the electronic lock in a case where an instruction to unlock the electronic lock is received. An instruction to lock or unlock the electronic lock may be transmitted to the processor 38 via a communication path or may be output to the processor 38 after being received by a receiving device provided in or around the door 28.

Note that the control device 30 may control a plurality of booth apparatuses 10 or a plurality of booth apparatuses 10A and the control device 30 may be provided for each booth apparatus 10 or each booth apparatus 10A.

For example, the processor 38 of the control device 30 detects a surface provided with the electronic blackboard 14 and controls the projecting device 16 such that an image is projected onto at least one surface out of surfaces provided with no electronic blackboard 14. For example, a camera that images the inside of the booth apparatus 10 is provided and the processor 38 analyzes an image captured by the camera to detect the surface provided with the electronic blackboard 14. Alternatively, the user may operate the UI 34 to designate the surface provided with the electronic blackboard 14. It is a matter of course that the user may designate a surface onto which an image is to be projected and the processor 38 may control the projecting device 16 such that the image is projected onto the surface designated by the user. Alternatively, in a case where the orientation of the projecting device 16 is determined in advance, the electronic blackboard 14 may be provided on a surface onto which no image is projected. For example, in a case where the projectors 16a and 16c are used, the electronic blackboard 14 is provided on the second surface 20a. In a case where the projectors 16b and 16c are used, the electronic blackboard 14 is provided on the first surface 18a.

The control device 30 and a management device 40 may constitute the entire system. The entire system may include at least one of the electronic blackboard 14 or the projecting device 16. The entire system may include devices other than the electronic blackboard 14 and the projecting device 16.

The control device 30 and the management device 40 communicate with each other via a communication path such as the Internet or a LAN.

The management device 40 manages reservations for use of the booth apparatus 10 or the booth apparatus 10A. Hereinafter, the management device 40 will be described below in detail. Hereinafter, processing performed in a case where the booth apparatus 10 is used will be described and the same processing as the processing performed in a case where the booth apparatus 10 is used is performed even in a case where the booth apparatus 10A is used.

The management device 40 includes a communication device 42, a UI 44, a memory 46, and a processor 48.

The communication device 42 includes one or more communication interfaces including, for example, a communication chip and a communication circuit and has a function of transmitting information to other devices and a function of receiving information from other devices. The communication device 42 may have a wireless communication function or a wired communication function.

The UI 44 is a user interface and includes a display and an operation device. The display is a liquid crystal display, an EL display, or the like. The operation device is a keyboard, a mouse, an input key, an operation panel, or the like. The UI 44 may be a UI such as a touch panel including both a display and an input device.

The memory 46 is a device that constitutes one or more storage areas for storage of data. Examples of the memory 36 include a hard disk drive (HDD), a solid state drive (SSD), various memories (for example, RAM, DRAM, NVRAM, ROM, and the like), another storage device (for example, an optical disk or the like), and a combination thereof.

The processor 48 controls the operation of each unit of the management device 40.

For example, the management device 40 associates information indicating a time for use of the booth apparatus 10 (that is, a time when use of the booth apparatus 10 is allowed) with user identification information for identification of a user who has made a reservation for the time for use and manages reservation information including such information. The time for use is determined by, for example, a date and a period of time. In a case where a plurality of booth apparatuses 10 are included in the entire system, the management device 40 associates information indicating a time for use with user identification information for each booth apparatus 10 so as to manage a reservation for each booth apparatus 10. In a case where a reservation for a time for use of the booth apparatus 10 is made by a user, the user is allowed to use the booth apparatus 10 during the time for use. Note that the reservation information may include user identification information for identification of a user entering the booth apparatus 10. In this case, the reservation information may include or may not include user information for identification of a user who has made a reservation for the booth apparatus 10. In a case where user authentication is to be performed in the booth apparatus 10, the user identification information for identification of a user entering the booth apparatus 10 is used to perform the user authentication. For example, there may be a person who has made a reservation on behalf of another person but does not use the booth apparatus 10, a person who has made a reservation for the booth apparatus 10 but cannot use the booth apparatus 10 for some reason, or the like. In such a case, user authentication is performed by means of user identification information for identification of a user entering the booth apparatus 10 in a case where reservation information includes the user identification information.

Reservation management information is stored in the memory 46. The reservation management information is information for management of a reservation for use of each booth apparatus 10. For example, the reservation management information is information including booth identification information for identification of the booth apparatus 10, time-for-use information indicating a time for use of the booth apparatus 10, and user identification information for identification of a user who has made a reservation for the booth apparatus 10. For each booth apparatus 10, the booth identification information, the time-for-use information, and the user identification information are associated with each other and are included in the reservation management information.

The booth identification information includes, for example, information indicating the name of the booth apparatus 10, the ID of the booth apparatus 10, and information (for example, position information) indicating a place where the booth apparatus 10 is provided.

The user identification information is information including, for example, information indicating the name of the user, an account (for example, the ID of the user, an e-mail address, or the like) of the user, or the like. The user identification information may include information (for example, a MAC address, an IP address, and a serial number) for identification of a terminal device used by the user. The user identification information may be biometric information of the user.

In a case where the processor 48 receives a request for a reservation for use of the booth apparatus 10 from a terminal device, the processor 48 registers the reservation for use of the booth apparatus 10 in the reservation management information. For example, in a case where a user operates a terminal device to request a reservation while designating the booth apparatus 10 to be used and a time for use of the booth apparatus 10, the processor 48 associates booth identification information of the booth apparatus 10, time-for-use information indicating the time for use, user identification information indicating the user who has made the reservation for the booth apparatus 10 with each other and registers the booth identification information, the time-for-use information, and the user identification information in the reservation management information. For example, the booth apparatus 10 may be reserved for each reservation unit time.

The management device 40 may be provided in the booth apparatus 10. That is, the booth apparatus 10 may manage a reservation for the booth apparatus 10. In addition, the management device 40 may be included in the control device 30.

Hereinafter, examples will be described.

### Example 1

In Example 1, the electronic blackboard 14 is provided on the second surface 20a and the projecting device 16 projects, under the control of the control device 30, an image onto any of the first surface 18a or the third surface 22a corresponding to the attribute of an authenticated user. For example, user authentication may be performed when a user enters the booth apparatus 10 or may be performed after the user enters the booth apparatus 10. For example, user identification information is used for the user authentication.

For example, the booth apparatus 10 is provided with a receiving device so that an IC card in which attribute information indicating the attribute of a user or a terminal device communicate with the receiving device and the attribute information is received by the receiving device. The processor 38 of the control device 30 receives the attribute information received by the receiving device.

Alternatively, attribute information of a user may be input and registered in reservation management information when the user makes a reservation for the booth apparatus 10. In this case, the attribute information is transmitted from the management device 40 to the control device 30 and the processor 38 receives the attribute information.

For example, the attribute of a user is the dominant hand of the user. In a case where the dominant hand a user is the right hand, the projecting device 16 projects an image onto the first surface 18a. In a case where the dominant hand of the user is the left hand, the projecting device 16 projects an image onto the third surface 22a. Hereinafter, projection control as above will be described.

In a case where a user who inputs information to the electronic blackboard 14 is right-handed, the user inputs the information to the electronic blackboard 14 with the right hand of the user, usually. In this case, the user may input information to the electronic blackboard 14 while referring to an image projected by the projecting device 16. In a case where the dominant hand of the user is the right hand information is to be input to the electronic blackboard 14, it is easier for the user to face the left of the user than to face the right of the user. In a case where the user inputs information to the electronic blackboard 14, the user usually faces the electronic blackboard 14. Therefore, in a case where an image is projected onto the first surface 18a which is on the left of the user based on the position of the user in a state of facing the electronic blackboard 14, it is easy for the user to see the projected image even when inputting the information to the electronic blackboard 14 in comparison with a case where the image is projected onto the third surface 22a instead of being projected onto the first surface 18a.

In a case where the user who inputs information to the electronic blackboard 14 is left-handed, the image is projected onto the third surface 22a so that it is easy for the user to see the projected image even when inputting the information to the electronic blackboard 14.

### Example 2

In Example 2, the electronic blackboard 14 is provided on the first surface 18a. In addition, the second surface 20a and the third surface 22a are connected to each other as shown in FIGS. 1 to 3 and one continuous surface is formed by the second surface 20a and the third surface 22a.

The projecting device 16 projects an image onto the second surface 20a and the third surface 22a under the control of the control device 30. For example, in a case where the display size (for example, the vertical width and the horizontal width) of an image to be projected is equal to or larger than a threshold value determined in advance, the projecting device 16 projects the image onto two surfaces (for example, the second surface 20a and the third surface 22a). The threshold value is determined based on the size (for example, the vertical width and the horizontal width) of each surface. In a case where the display size of an image to be projected is larger than the size of one surface, the entire image cannot be displayed on the one surface. Therefore, in Example 2, the projecting device 16 projects the image onto two surfaces. Since one continuous large surface is formed by the second surface 20a and the third surface 22a, the entire image can be projected onto the surface even in a case where the entire image cannot be displayed on one surface.

In a case where the electronic blackboard 14 is provided on the third surface 22a, the projecting device 16 projects an image onto the first surface 18a and the second surface 20a.

### Example 3

In Example 3, under the control of the control device 30, the projecting device 16 projects information input to the electronic blackboard 14 onto at least one surface out of the first surface 18a, the second surface 20a, or the third surface 22a on which the electronic blackboard 14 is not provided.

For example, in a case where the electronic blackboard 14 is provided on the second surface 20a, the projecting device 16 projects information input to the electronic blackboard 14 onto the first surface 18a or the third surface 22a under the control of the control device 30. The projecting device 16 may project the information input to the electronic blackboard 14 onto both the first surface 18a and the third surface 22a under the control of the control device 30.

In a case where the information input to the electronic blackboard 14 is to be projected onto the at least one surface, the projecting device 16 may project the information to be gradually moved from the electronic blackboard 14 side. In this case, the projecting device 16 may project, onto the at least one surface, an image indicating the position of the start of projection of the information on the at least one surface.

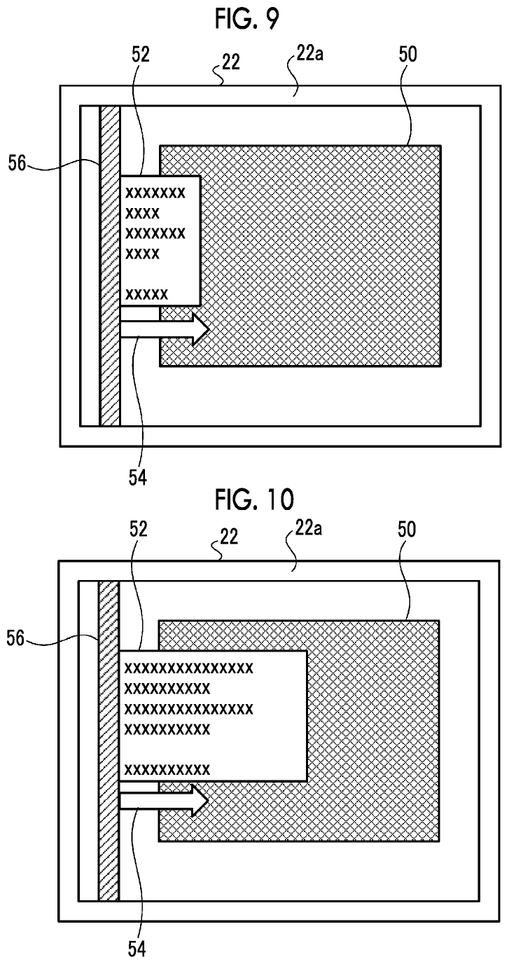

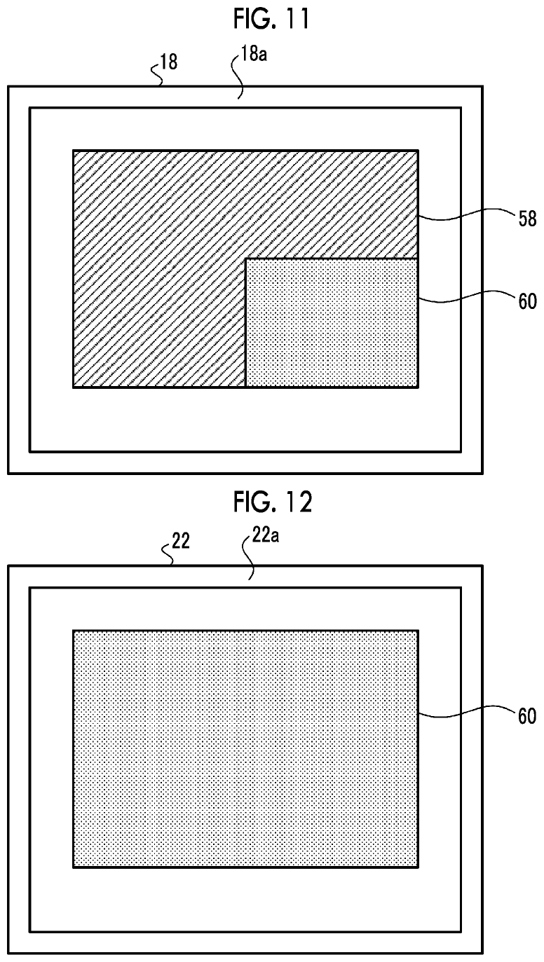

Hereinafter, an example of projection of information input to the electronic blackboard 14 will be described with reference to FIGS. 9 and 10. FIG. 9 and FIG. 10 are views showing the third surface 22a. Here, for example, the electronic blackboard 14 is provided on the second surface 20a and information input to the electronic blackboard 14 is projected onto the third surface 22a.

As shown in FIGS. 9 and 10, an image 50 is projected onto the third surface 22a. The image 50 is not an image showing the information input to the electronic blackboard 14, but an image that is received by the control device 30 as a target to be projected.

In a case where information is input to the electronic blackboard 14, the projecting device 16 projects the information input to the electronic blackboard 14 onto the third surface 22a under the control of the control device 30. For example, the projecting device 16 projects an image 52 showing the information input to the electronic blackboard 14 onto the third surface 22a. In this case, the projecting device 16 may project the image 52 to be superimposed on the image 50.

The projecting device 16 projects the image 52 onto the third surface 22a to be gradually moved from the second surface 20a side on which the electronic blackboard 14 is provided. In an example shown in FIG. 9, since the second surface 20a is formed on the left side of the third surface 22a, the projecting device 16 projects the image 52 onto the third surface 22a to be gradually moved from the left side to the right side of the third surface 22a. As shown in FIG. 10, the projecting device 16 projects the image 52 onto the third surface 22a to be gradually moved with time in a direction represented by an arrow 54. As described above, the projecting device 16 causes the image 52 to be gradually moved from the left side to the right side of the third surface 22a.

In addition, the projecting device 16 projects an image 56 onto a position on the third surface 22a where projection of the image 52 is started. The image 56 is an image showing the position of the start of projection of the image 52 and is displayed to be distinguished from other images, for example. For example, the image 56 is an image a color and a brightness different from other images and is displayed with emphasis. Accordingly, a user of the booth apparatus 10 can recognize from which position the image 52 is started to be displayed.

In the examples shown in FIGS. 9 and 10, a case where the electronic blackboard 14 is provided on the second surface 20a and an image is projected onto the third surface 22a has been described. However, such a case is merely an example. Even in a case where the electronic blackboard 14 is provided on a surface other than the second surface 20a, processing as in Example 3 is performed.

### Example 4

In Example 4, the projecting device 16 projects an image onto two surfaces out of the first surface 18a, the second surface 20a, or the third surface 22a on which the electronic blackboard 14 is not provided. For example, one of the two surfaces is determined as a first projection screen and the other of the two surfaces is determined as a second projection screen. The projecting device 16 projects a first image showing first information onto the first projection screen and a second image showing second information onto the second projection screen.

For example, in a case where the first information is selected by a user as information to be projected, the projecting device 16 projects the first image showing the first information onto the first projection screen. The processor 38 of the control device 30 acquires the second information related to the first information and the projecting device 16 projects the second image showing the second information onto the second projection screen.

The second information is information related to the first information. For example, the first information and the second information are files such as data. In a case where the first information is moving image data, voice data obtained together with the moving image data is the second information. In addition, in a case where the first information is CAD data, data representing a geometry net of an object represented by the CAD data is the second information. In a case where the first information is subjected to processing, the second information may be information before the processing. For example, history information indicating the history of processing with respect to the first information is associated with the first information and the processor 38 of the control device 30 acquires the second information by referring to the history information. The second information may be information created by a creator of the first information. The second information may be selected by the user.

The first projection screen and the second projection screen may be designated by the user or may be determined in advance.

For example, the first information and the second information which are files are stored in an external device such as a document management system or an image server, a terminal device of the user, the control device 30, or the like. In a case where the first information is selected by the user, the projecting device 16 acquires the first information from the external device or the like and projects the first image showing the first information onto the first projection screen. The processor 38 of the control device 30 acquires the second information related to the first information from the external device or the like, and causes the second image showing the second information to be projected onto the second projection screen.

The projecting device 16 may project, onto the first projection screen, the second image included in the first image. For example, there is a case where a file such as CAD data includes a plurality of pieces of information to be projected. In this case, after the first information is selected from the file, the second information related to the first information is selected and the second image showing the second information is projected.

An example where the second image included in the first image is displayed will be described with reference to FIGS. 11 and 12. FIG. 11 is a view showing the first surface 18a. FIG. 12 is a view showing the third surface 22a. Here, for example, the electronic blackboard 14 is provided on the second surface 20a, the first surface 18a is the first projection screen, and the third surface 22a is the second projection screen.

For example, in a case where an image 58 is selected by the user as an image to be projected, the projecting device 16 projects the image 58 onto the first surface 18a as shown in FIG. 11. The image 58 is an example of the first image. The image 58 is, for example, an image showing the entire body of a certain device. The image 58 includes an image 60 showing a component of the device. The image 60 is an example of the second image.

In a case where the image 60 is selected by the user from the image 58 displayed on the first surface 18a, the projecting device 16 projects the selected image 60 onto the third surface 22a as shown in FIG. 12. That is, the projecting device 16 projects, onto the third surface 22a which is different from the first surface 18a on which the image 58 is displayed, the image 60 included in the image 58. In such a manner, the projecting device 16 projects the first image and the second image onto different surfaces, respectively. The user can see and compare the first image and the second image on the different surfaces. For example, the projecting device 16 enlarges the image 60 and projects the enlarged image 60 onto the third surface 22a. Accordingly, the user can check the details of a component shown in the image 60.

Note that the projecting device 16 may project the image 60 onto the first surface 18a, on which the image 58 is displayed, corresponding to the display sizes of the images 58 and 60 or the size of the component shown in the image 60. For example, in a case where the image 58 and the image 60 are to be projected onto the same surface without being superimposed on each other, the projecting device 16 projects the image 58 and the image 60 onto the same first surface 18a. The projecting device 16 may project the image 58 and the image 60 onto the same first surface 18a or may respectively project the image 58 and the image 60 on different surfaces in accordance with an instruction made by the user.

Note that in Example 4, the electronic blackboard 14 may not be included in the booth apparatus 10. That is, Example 4 may be implemented without use of the electronic blackboard 14.

### Example 5

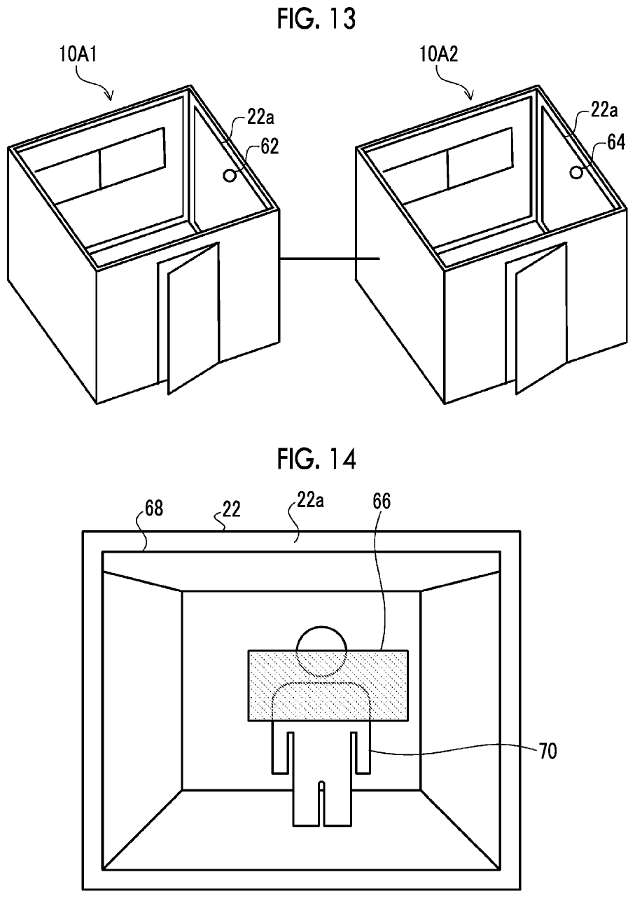

In Example 5, the projecting device 16 projects, onto at least one surface out of the first surface 18a, the second surface 20a, or the third surface 22a, an image projected onto a surface of another booth apparatus. Hereinafter, Example 5 will be described with reference to FIGS. 13 and 14. FIG. 13 is a perspective view showing booth apparatuses 10A1 and 10A2. FIG. 14 is a view showing a surface of the booth apparatus 10A1.

Here, for example, the booth apparatuses 10A are used as booth apparatuses. However, the same processing as processing performed in a case where the booth apparatuses 10A are used is performed even in a case where the booth apparatuses 10 are used.

The booth apparatuses 10A1 and 10A2 have the same configuration as the booth apparatuses 10A. Here, in order to distinguish between the two booth apparatuses 10A shown in FIG. 13, one booth apparatus 10A will be referred to as the “booth apparatus 10A1” and the other booth apparatus 10A will be referred to as the “booth apparatus 10A2”.

For the sake of convenience of description, the control device 30 provided in the booth apparatus 10A1 will be referred to as a “control device 301”, and the control device 30 provided in the booth apparatus 10A2 will be referred to as a “control device 302”. The processor 38 included in the control device 301 will be referred to as a “processor 381”, and the processor 38 included in the control device 302 will be referred to as a “processor 382”.

The control devices 301 and 302 communicate with each other via a communication path to transmit and receive images and other information to and from each other. For example, the control device 301 receives a first image projected onto a surface of the booth apparatus 10A2 from the control device 302, and the projecting device 16 of the booth apparatus 10A1 projects the first image onto a surface of the booth apparatus 10A1 under the control of the control device 301. The surface of the booth apparatus 10A1 onto which the first image is projected is a surface on which no electronic blackboard 14 is provided. The surface of the booth apparatus 10A1 onto which the first image is projected may be a surface of the booth apparatus 10A1 onto which no image has been projected until then.

For example, in a case where the electronic blackboard 14 is provided on the second surface 20a and an image has been projected onto the first surface 18a in the booth apparatus 10A1, the first image is projected onto the third surface 22a. The surface of the booth apparatus 10A1 onto which the first image is projected may be designated by a user of the booth apparatus 10A1 or may be determined in advance.

According to Example 5, the first image projected onto a surface of the booth apparatus 10A2 is shared by a user of the booth apparatus 10A1 and a user of the booth apparatus 10A2.

Similarly, an image projected onto a surface of the booth apparatus 10A1 may be projected onto a surface of the booth apparatus 10A2.

A camera 62 may be provided on a surface of the booth apparatus 10A1 to image the inside of the booth apparatus 10A1. In an example shown in FIG. 13, the camera 62 is provided on the third surface 22a of the booth apparatus 10A1. Such a case is merely an example and the camera 62 may be provided on the first surface 18a or the second surface 20a, may be provided on a plurality of surfaces, or may be provided on a ceiling or the like.

A camera 64 may be provided on a surface of the booth apparatus 10A2 to image the inside of the booth apparatus 10A2. In an example shown in FIG. 13, the camera 64 is provided on the third surface 22a of the booth apparatus 10A2. Such a case is merely an example and the camera 64 may be provided on the first surface 18a or the second surface 20a, may be provided on a plurality of surfaces, or may be provided on a ceiling or the like.

A camera may be provided in only one of the booth apparatus 10A1 or the booth apparatus 10A2.

For example, the control device 301 of the booth apparatus 10A1 receives, from the control device 302 of the booth apparatus 10A2, the second image captured by the camera 64. The projecting device 16 of the booth apparatus 10A1 projects the second image onto a surface of the booth apparatus 10A1 under the control of the control device 301. The surface of the booth apparatus 10A1 onto which the second image is projected is a surface on which no electronic blackboard 14 is provided. The surface of the booth apparatus 10A1 onto which the second image is projected may be a surface of the booth apparatus 10A1 onto which no image has been projected until then.

The projecting device 16 of the booth apparatus 10A1 may project, under the control of the control device 301, the second image onto a surface of the booth apparatus 10A1 to be superimposed on the first image. For example, the projecting device 16 of the booth apparatus 10A1 projects the first image onto the third surface 22a and projects the second image onto the third surface 22a to be superimposed on the first image. In a case where a person is shown in the second image, an image of the person in the second image may be subjected to a translucentization process. The translucentization process is performed by the control device 301 or the control device 302. The transparency in the translucentization process may be designated by a user of the booth apparatus 10A1 or the booth apparatus 10A2 or may be set in advance.

FIG. 14 shows an example of the way in which the first image and the second image are displayed to be superimposed on each other. FIG. 14 shows the third surface 22a of the booth apparatus 10A1. Here, for example, the projecting device 16 of the booth apparatus 10A1 projects a first image 66 onto the third surface 22a. For example, the first image 66 is an image projected onto a surface (for example, the first surface 18a) of the booth apparatus 10A2. The projecting device 16 of the booth apparatus 10A1 projects a second image 68 onto the third surface 22a to be superimposed on the first image 66. The second image 68 is an image captured by the camera 64 provided on the third surface 22a of the booth apparatus 10A2. The second image 68 shows the inside of the booth apparatus 10A2. In addition, the second image 68 shows a person 70 in the booth apparatus 10A2. An image of the person 70 is subjected to a translucentization process.

The first image 66 may be an image selected by the user of the booth apparatus 10A2 or may be an image selected by the user of the booth apparatus 10A1. That is, in a case where the first image 66 is projected onto a surface of the booth apparatus 10A1, the user of the booth apparatus 10A2 may have the authority to switch the first image 66 or the user of the booth apparatus 10A1 may have the authority to switch the first image 66.

The image of the person 70 may be subjected to a reversing process of reversing right and left sides thereof. The reversing process may be performed by the control device 301 or may be performed by the control device 302. The orientation of the camera 64 is opposite to the orientation of the projecting device 16 of the booth apparatus 10A2. Therefore, in a case where the image of the person 70 is superimposed on the first image 66 without reversing the right and left sides of the image of the person 70, rightward and leftward directions of the person 70 are made opposite to rightward and leftward directions in the first image 66. As a result, a position pointed by the person 70 in the booth apparatus 10A2 is displayed in the second image 68 displayed in the booth apparatus 10A1 as if the person 70 has pointed the opposite position in a right-left direction. Therefore, the user of the booth apparatus 10A1 feels a feeling of wrongness. In a case where the image of the person 70 is superimposed on the first image 66 after reversing the right and left sides of the image of the person 70, the rightward and leftward directions of the person 70 coincide with the rightward and leftward directions in the first image 66 and thus the feeling of wrongness felt by the user of the booth apparatus 10A1 is reduced.

The control device 301 of the booth apparatus 10A1 may transmit an image projected onto a surface of the booth apparatus 10A1 onto which the first image 66 is not projected to the booth apparatus 10A2 so that the image is projected onto a surface of the booth apparatus 10A2. For example, an image projected onto the first surface 18a of the booth apparatus 10A1 is transmitted to the booth apparatus 10A2 from the booth apparatus 10A1 and is projected onto the third surface 22a of the booth apparatus 10A2.

In addition, an image captured by the camera 62 of the booth apparatus 10A1 may be transmitted to the booth apparatus 10A2 to be projected onto a surface of the booth apparatus 10A2.

Note that in Example 5, the electronic blackboard 14 may not be included in the booth apparatus 10. That is, Example 5 may be implemented without use of the electronic blackboard 14.

The booth apparatus 10A1 and the booth apparatus 10A2 may constitute a system.

Three or more booth apparatuses 10A may constitute a system. The size and the shape of booth apparatuses included in a system may be the same as each other or may be different from each other. Note that, the booth apparatus 10 and the booth apparatus 10A may constitute a system.

### Example 6

Under the control of the control device 30, the projecting device 16 may project, onto a surface corresponding to the size of an image to be projected, the image to be projected.

For example, information indicating the size of an image is attached to the image. The processor 38 of the control device 30 selects, based on information indicating the size of any of the first surface 18a, the second surface 20a, or the third surface 22a on which the electronic blackboard 14 is not provided and information indicating the size of an image to be projected, a surface on which the image is to be displayed. Information indicating the size of each surface is stored in advance in the memory 36 of the control device 30. For example, the processor 38 selects a surface on which the image can be displayed at full size. The projecting device 16 projects the image onto the surface selected by the processor 38.

For example, CAD data includes drawing information including information indicating a size, information indicating a specification, design information, and the like. The processor 38 recognizes the size of an image represented by the CAD data by referring to such information, and selects a surface onto which the image is to be projected.

### Example 7

In Example 7, the booth apparatus 10 includes a microphone. The microphone collects a voice in the booth apparatus 10. The processor 38 of the control device 30 analyzes the voice collected by the microphone to create a text string representing the voice. A known technique is used for a voice analysis process or a process of creating a text string from a voice. The projecting device 16 projects the text string onto at least one surface of the booth apparatus 10 under the control of the control device 30. For example, in a case where the electronic blackboard 14 is provided on the second surface 20a, the text string is projected onto at least one surface out of the first surface 18a or the third surface 22a. A surface onto which the text string is projected may be designated by a user or may be determined in advance.

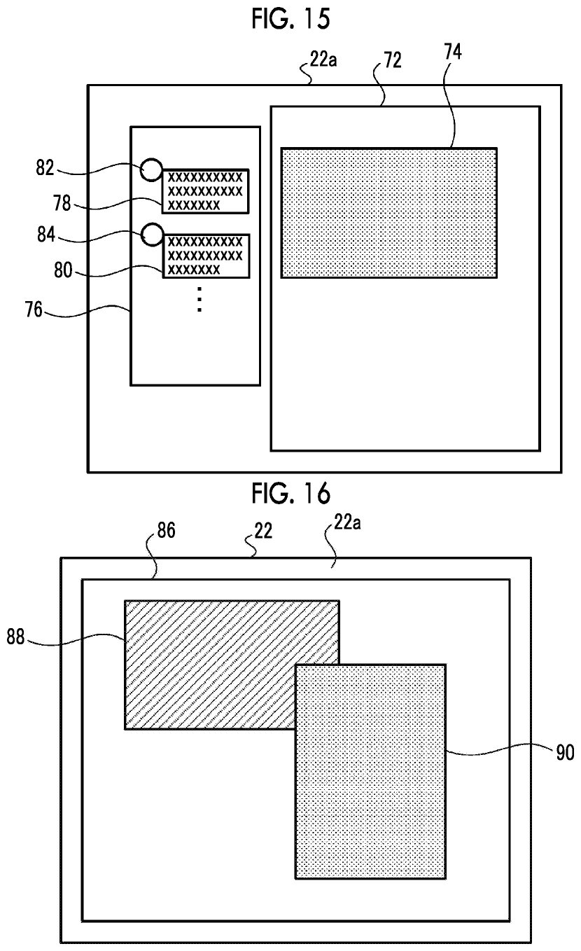

FIG. 15 shows an example of the way in which a text string representing a voice is displayed. FIG. 15 is a view showing the third surface 22a of the booth apparatus 10. Here, for example, an image 72 is projected onto the third surface 22a. The image 72 includes an image 74 showing a document such as documentary literature.

The projecting device 16 projects a list 76 of text strings onto the third surface 22a. The list 76 includes one or a plurality of text strings. Here, for example, text strings 78, 80, . . . and so forth are included in the list 76. The text strings 78, 80, . . . and so forth are text strings representing voices collected by the microphone. The processor 38 of the control device 30 arranges the text strings 78, 80, . . . and so forth in a chronological order in which the voices are collected, and causes the projecting device 16 to project the text strings 78, 80, . . . and so forth. The processor 38 may recognize a person who generated a voice from the voice, associate an image (for example, an icon or a thumbnail image) showing the person with a text string representing the voice, and cause the projecting device 16 to project the image and the text string. The image showing the person is an image showing the face of the person, an image showing the name, the account name, or the like of the person, or the like. A known recognition technique is used for a process of recognizing a person who has generated a voice. For example, voice data representing a voice of a user is stored in the memory 36 in advance and the processor 38 recognizes a person who has generated the voice by referring to the voice data stored in the memory 36.

In an example shown in FIG. 15, an image 82 is projected in association with the text string 78 and an image 84 is projected in association with the text string 80. Specifically, the image 82 is projected onto the vicinity of the text string 78, and the image 84 is projected onto the vicinity of the text string 80. The image 82 is an image showing a person who has emitted a voice that the text string 78 represents. The image 84 is an image showing a person who has emitted a voice that the text string 80 represents.

In a case where a voice coinciding with a keyword registered in advance is collected, the processor 38 may cause the projecting device 16 to project a text string representing voices collected during time periods before and after a time point at which the voice representing the keyword is emitted. The length of the time periods before and after such time point may be set in advance or may be set by a user.

The processor 38 may specify the orientation of the person who has emitted the voice and the projecting device 16 may project a text string representing the voice onto a surface that the person faces and that is ahead of the person. For example, a person is imaged by a camera provided in the booth apparatus 10 and the processor 38 analyzes an image generated through such an imaging operation to specify the orientation of the person (for example, the line of sight of the person or a direction in which the face of the person faces). The projecting device 16 projects a text string representing a voice emitted by the person onto a surface to which the orientation extends.

For example, in a case where a person who has emitted a voice is seeing the first surface 18a, the projecting device 16 projects a text string representing the voice onto the first surface 18a.

In a case where a person emits a voice while seeing the first surface 18a and then emits a voice while seeing the third surface 22a, the projecting device 16 projects a text string representing the voice of the person onto the first surface 18a and then projects a text string representing the voice of the person onto the third surface 22a. In a case where the text string representing the voice of the person is projected onto the third surface 22a, the projecting device 16 may not project, onto a surface, the text string projected onto the first surface 18a and the text string may be projected onto the third surface 22a.

The projecting device 16 may project a text string representing a voice onto a specific surface regardless of the orientation of a person who has emitted the voice. For example, the projecting device 16 projects the text string representing the voice onto the third surface 22a. In this case, under the control of the control device 30, the projecting device 16 projects the text string onto the third surface 22a in a display style corresponding to the orientation of the person who has emitted the voice. For example, the projecting device 16 performs projection onto the third surface 22a in such a style that the orientation of the person who has emitted the voice can be identified. For example, the display style is a text color, a font type, a text size, decoration with respect to a text, or the like.

For example, in a case where a person emits a voice while seeing the first surface 18a, the projecting device 16 projects a red text string representing the voice onto the third surface 22a. In a case where a person emits a voice while seeing the second surface 20a, the projecting device 16 projects a red text string representing the voice onto the third surface 22a. Accordingly, a text string representing a voice emitted by a person seeing the first surface 18a and a text string representing a voice emitted by a person seeing the second surface 20a are projected such that the text strings can be distinguished from each other. Accordingly, a person who sees the third surface 22a can recognize which direction a person, who has emitted a voice represented by a text string projected onto the third surface 22a, has faced. The processor 38 may change a font, a text size, or decoration while changing the color of the text string or without changing the color of the text string.

The projecting device 16 may project a text string representing a voice onto a surface (for example, the third surface 22a) in a case where a person emits the voice while facing a specific direction and not project a text string representing a voice onto the surface (for example, the third surface 22a) in a case where a person emits the voice while facing a direction other than the specific direction. For example, in a case where a person emits a voice while seeing the first surface 18a, the projecting device 16 projects a text string representing the voice onto the third surface 22a. In a case where a person emits a voice while seeing a surface other than the first surface 18a, the projecting device 16 does not project a text string representing the voice onto the third surface 22a.

The projecting device 16 may project a text string representing a voice onto a surface closest to a person who has emitted the voice. For example, the person and each surface are imaged by a camera provided in the booth apparatus 10 and the processor 38 calculates a distance between the person and each surface based on an image generated through such an imaging operation to specify a surface closest to the person. The projecting device 16 projects a text string representing a voice emitted by the person onto the surface closest to the person.

### Example 8

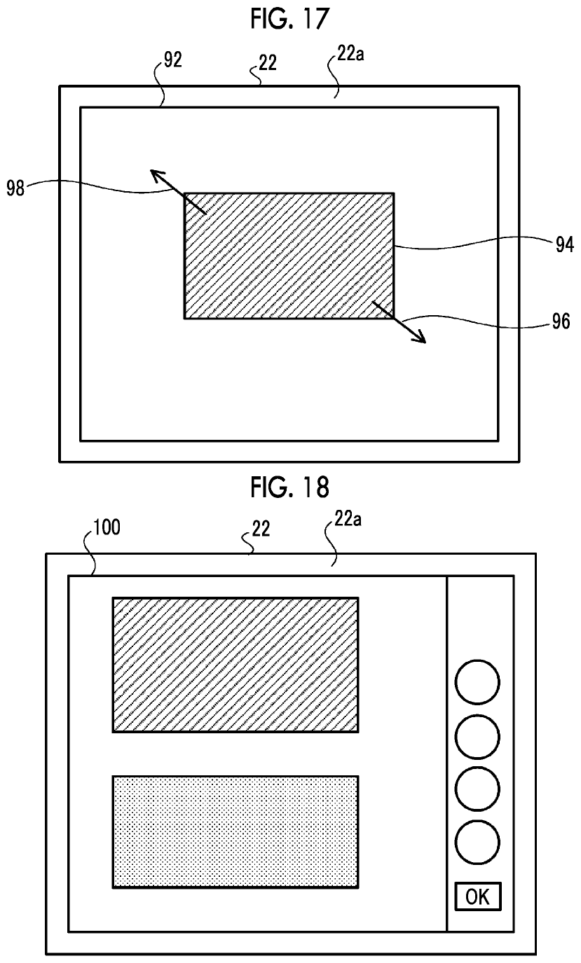

An example of an operation performed on an image projected onto a surface in the booth apparatus 10 will be described with reference to FIGS. 16 and 17. FIGS. 16 and 17 are views showing the third surface 22a.

As shown in FIG. 16, an image 86 is projected onto the third surface 22a. The image 86 includes images 88 and 90.

For example, a hand tracking sensor is provided in the booth apparatus 10 to detect the movement of a hand of a person. For example, hand tracking sensors are provided on the first surface 18a, the second surface 20a, and the third surface 22a, and the processor 38 detects the movement of a hand based on the result of detection performed by the hand tracking sensors. A hand tracking sensor may be provided on a ceiling, a device provided on the ceiling, a surface in the booth apparatus 10, or the like.

For example, in a case where the image 90 is projected to be closer to a rear surface side than the image 88 is and a user designates the image 90 on the third surface 22a, the projecting device 16 projects the image 90 to be closer to a front surface side than the image 88 is. The positions of the projected images may be changed in accordance with the movement of a hand. The processor 38 may switch an image to be projected in accordance with the movement of a hand. In addition, in a case where the user moves a hand of the user from one surface (for example, the first surface 18a) to another surface (for example, the second surface 20a), the projecting device 16 may perform projection such that an image projected onto the first surface 18a is moved to the second surface 20a.

FIG. 17 shows an example of an operation at the time of an increase in size of an image. An image 92 is projected onto the third surface 22a. The image 92 includes an image 94. For example, in a case where a user moves the hands of the user in directions to enlarge the image 94 as represented by arrows 96 and 98, the projecting device 16 projects the image 94 onto the third surface 22a to be enlarged. In addition, in a case where a user moves the hands of the user in directions to reduce the image 94, the projecting device 16 projects the image 94 onto the third surface 22a to be reduced.

### Example 9

In Example 9, in a case where a reservation for use of the booth apparatus 10 is made and a user who has made the reservation is authenticated for the use of the booth apparatus 10, the processor 38 of the control device 30 turns on the projecting device 16.

As described above, a reservation for the booth apparatus 10 may be managed by the management device 40 or may be managed by the control device 30 of the booth apparatus 10. For example, in a case where a reservation for the booth apparatus 10 is made, reservation information indicating the reservation is stored in the memory 36 of the control device 30. For example, the reservation information includes user identification information for identification of a user who has made the reservation, information indicating a date and time of the reservation, and the like.

For example, a camera is provided outside the booth apparatus 10 and a person in the vicinity of the booth apparatus 10 or a person approaching the booth apparatus 10 is imaged by the camera. The processor 38 of the control device 30 recognizes the person in the vicinity of the booth apparatus 10 or the person approaching the booth apparatus 10 based on an image generated through such an imaging operation. A known technique is used for a recognition process. The processor 38 determines whether or not the person has made a reservation for the booth apparatus 10 based on the result of the recognition and user identification information stored in the memory 36. In this case, the processor 38 acquires, from the memory 36, reservation information including a reserved time at time periods before and after a time at which the person has been imaged and collates the user identification information included in the reservation information with the result of the recognition. In a case where the user identification information of the person is included in the reservation information and stored in the memory 36, authentication succeeds. In a case where the authentication is successful, the processor 38 turns on the projecting device 16. The processor 38 may turn on a device such as a speaker or a light. Note that, as user authentication, authentication in which an IC card is used or authentication (that is, biometric authentication) in which biometric information is used may also be used.

Setting information (for example, information indicating the volume of a speaker or the like) used at the time of previous use of the booth apparatus 10 may be stored in the memory 36. In this case, the processor 38 may set various devices in advance in accordance with the setting information. For example, the processor 38 sets various devices before a user enters the booth apparatus 10.

The last projected image at the time of previous use of the booth apparatus 10 may be stored in the memory 36. In this case, the projecting device 16 may project the image onto a surface in the booth apparatus 10 under the control of the control device 30. For example, the projecting device 16 projects the image onto the surface before a user enters the booth apparatus 10. The projecting device 16 may project the image on the same surface as before. FIG. 18 shows an example of such projection. For example, the projecting device 16 projects an image 100 onto the same third surface 22a as before.

The processor 38 may start application software used at the time of previous use of the booth apparatus 10 in advance.

The processor 38 may perform user authentication when a user approaches the booth apparatus 10 and turn on the projecting device 16 in a case where the authentication is successful and may cause a previous image to be projected onto a surface in the booth apparatus 10 in a case where the user enters the booth apparatus 10.

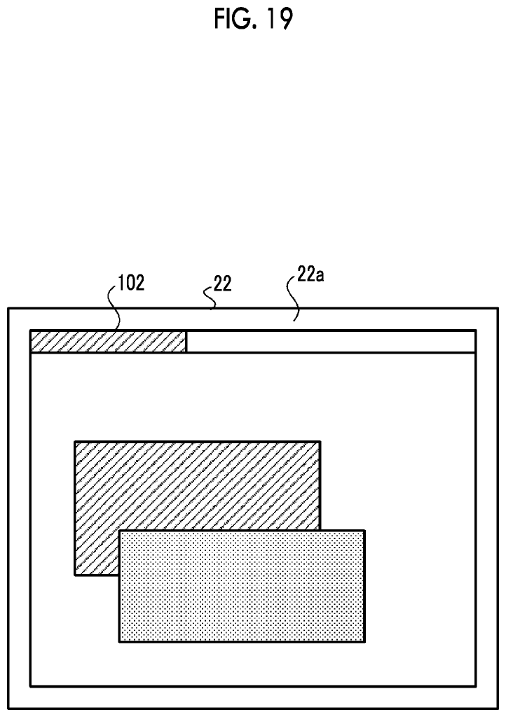

Under the control of the control device 30, the projecting device 16 may project information indicating the remaining reserved time for the booth apparatus 10 onto a surface in the booth apparatus 10. FIG. 19 shows an example of such projection. FIG. 19 is a view showing the third surface 22a. The projecting device 16 projects, onto the third surface 22a, an image 102 showing the entire reserved time. The image 102 is an image showing the remaining reserved time like an indicator or the like, for example.

### Second Exemplary Embodiment

Hereinafter, an information processing device according to a second exemplary embodiment will be described.

For example, the information processing device according to the second exemplary embodiment includes a communication device, a UI, a memory, and a processor. The information processing device may be a terminal device or may be the control device 30 according to the first exemplary embodiment.

The processor of the information processing device according to the second exemplary embodiment associates a first file image showing a file associated with an account of a first user and a first user image showing the first user with each other and causes the images to be displayed. In addition, the processor associates a second file image showing a file associated with an account of a second user different from the first user and a second user image showing the second user with each other and causes the images to be displayed together with the first file image and the first user image.

The files are document data, image data (for example, still image data or moving image data), voice data, or the like but are not limited thereto. The format of the files may be any format. The files may be stored in the information processing device or may be stored in an external device (for example, a file server, a document management system, a terminal device of a user, or another server) other than the information processing device.

The file images are, for example, icons, thumbnail images of the files, or the like. The user images are images for identification of the users and are, for example, images showing the faces of the users, images (for example, images showing text strings) showing the names of the users, abbreviations thereof, or account names, or images showing characters or avatars, but are not limited thereto.

An account is information used when a user logs in to a service or an apparatus. For example, logging in to a service or an apparatus means logging in to a cloud service, an online storage, a document management system, a file server, the booth apparatuses 10 and 10A, or the like. For example, an account is created for each user and the account of each user is managed by a device or a system that provides a service. In addition, an account is created for each service or device to which a user logs in. Single sign-on may be realized with each account being associated with the same user.

Causing the file images and the user images to be displayed may mean causing a display to display the file images and the user images or may means causing a projecting device to project the file images and the user images.

For example, the processor causes the display to display the first file image and the first user image and causes the display to display the second file image and the second user image.

The processor may cause the display to display the first user image and the second user image together with each other and cause the display to display a file image associated with a selected user image in a case where the user image is selected. In this case, the processor cause the display not to display a file image associated with a user image that is not selected. For example, in a case where the first user image is selected, the processor causes the display to display the first file image and cause the display not to display the second file image.

Alternatively, the processor causes the projecting device to project the first file image and the first user image and causes the projecting device to project the second file image and the second user image. For example, the projecting device projects the images onto the same projection surface. In a case where the second exemplary embodiment is applied to the first exemplary embodiment, the images are projected onto a surface in the booth apparatus 10 or the booth apparatus 10A.

The processor may cause the first file image and the second file image to be displayed to be distinguished from each other. For example, the processor causes the first file image and the second file image to be displayed at different positions so that the images are distinguished from each other. Alternatively, the processor may cause one of the first file image or the second file image to be displayed. For example, the processor causes the first user image and the second user image to be arranged and displayed. In a case where the first user image is selected, the processor may cause the first file image to be displayed without causing the second file image to be displayed. In a case where the second user image is selected, the processor may cause the second file image to be displayed without causing the first file image to be displayed.

The processor may cause the projecting device to project the first user image and the second user image together with each other and cause the projecting device to project a file image associated with a selected user image in a case where the user image is selected. In this case, the processor causes the projecting device not to project a file image associated with a user image that is not selected. For example, in a case where the first user image is selected, the processor causes the projecting device to project the first file image and causes the projecting device not to project the second file image.

The first file image includes an image showing a file associated with a first account of the first user and an image showing a file associated with a second account of the first user. The second account is an account different from the first account and is an account associated with the first account. For example, the first account is an account used to log in to a certain service or device and the second account is an account used to log in to another service or device. The first account and the second account are managed in association with each other. Regarding the second file image, as with the first file image, the second file image includes images respectively associated with a plurality of accounts different from each other.

For example, the first account is an account for use of a specific place. The specific place is the booth apparatus 10, the booth apparatus 10A, a room, a seat, a conference room, an office, a store, or another space. In a case where the first user uses the specific place, the processor causes the first file image and the first user image to be displayed in association with each other. For example, in a case where the first user uses the booth apparatus 10 or the booth apparatus 10A, the processor causes the projecting device 16 to project the first file image and the first user image in association with each other. Accordingly, the first file image is projected onto a surface in the booth apparatus 10 or the booth apparatus 10A.

For example, in a case where user authentication with respect to a user succeeds when the user uses the booth apparatus 10 or the booth apparatus 10A, the processor causes the projecting device 16 to project the first file image and the first user image in association with each other. The first file image projected in this case may be an image showing a file stored in a terminal device of the user or may be an image showing a file stored in the control device 30 or a device such as an online storage.

In a case where the second user uses the specific place together with the first user, the processor displays the second user image together with the first user image. For example, an account of the first user and an account of the second user are registered in the management device 40 when the first user makes a reservation for the booth apparatus 10A. In a case where user authentication with respect to the first user succeeds when the booth apparatus 10A is used, the processor causes the projecting device 16 to project the first user image and the second user image. Accordingly, respective user images of a plurality of users using the booth apparatus 10A together are projected. In a case where the first user image is selected, the processor causes the projecting device 16 to project the first file image and causes the projecting device 16 not to project the second file image. In a case where the second user image is selected, the processor causes the projecting device 16 to project the second file image and causes the projecting device 16 not to project the first file image. The processor may cause the projecting device 16 to project the first file image together with the second file image.

In a case where a file image is projected onto a surface of the booth apparatus 10 or the booth apparatus 10A, the projecting device 16 may project an image, which is obtained from a file associated with an account of the first user, onto a surface (for example, the first surface 18a) and project an image, which is obtained from another file associated with the account of the first user, onto another surface (for example, the third surface 22a) under the control of the control device 30.

In a case where the first user and the second user uses the booth apparatus 10 or the booth apparatus 10A together, the projecting device 16 may project an image, which is obtained from a file associated with an account of the first user, onto a surface (for example, the first surface 18a) and project an image, which is obtained from a file associated with an account of the second user, onto another surface (for example, the third surface 22a) under the control of the control device 30.

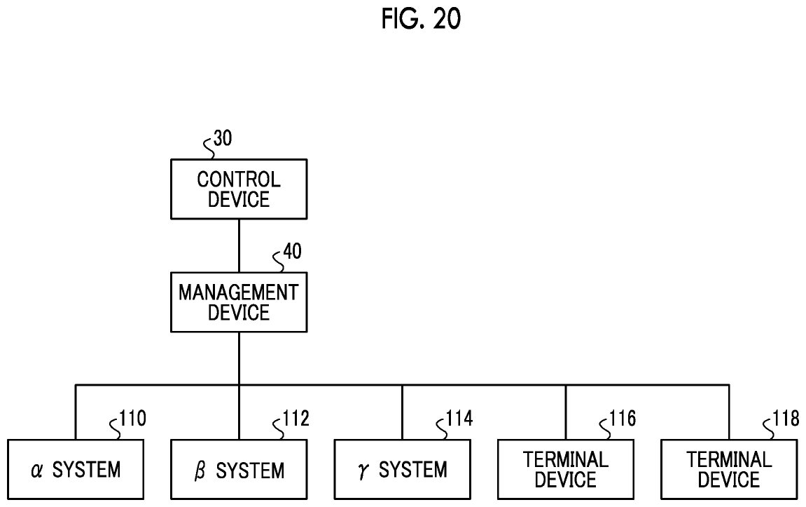

Hereinafter, the second exemplary embodiment will be described with reference to a specific example. Hereinafter, a case where processing according to the second exemplary embodiment is performed at the booth apparatus 10 or the booth apparatus 10A will be described as an example. However, such a case is merely an example. The processing according to the second exemplary embodiment may also be performed in a case where the booth apparatuses 10 and 10A are not used. FIG. 20 shows a configuration of an example of the entire system according to the second exemplary embodiment.

For example, the entire system according to the second exemplary embodiment includes the control device 30, the management device 40, one or more systems, and one or more terminal devices. In an example shown in FIG. 20, the entire system includes an a system 110, a β system 112, a γ system 114, and terminal devices 116 and 118. Each of the devices and the systems included in the entire system communicate with each other via a communication path such as the Internet or a LAN. For example, the control device 30 corresponds to an example of the information processing device according to the above-described second exemplary embodiment.

For example, the α system 110, the β system 112, and the γ system 114 are online storages, document management systems, file servers, or other servers, and store files.

In each of the α system 110, the β system 112, and the γ system 114, an account for a user to use the system is created and registered. For example, different accounts are respectively created and registered in the systems. Each system manages a file for each account. For example, a user can log in to the α system 110 by using an account for the α system 110. The same applies to other systems.

The terminal devices 116 and 118 are, for example, a PC, a tablet PC, a smartphone, a portable phone, or the like used by a user. For example, the terminal device 116 is a terminal device used by a user A and the terminal device 118 is a terminal device used by a user. Files are stored in the terminal devices 116 and 118.

In addition, an account for use of the booth apparatus 10 or the booth apparatus 10A is registered in the management device 40 for each user. For example, a user makes a reservation for the booth apparatus 10 or the booth apparatus 10A by using an account of the user. In addition, authentication in the booth apparatus 10 is performed or the electronic lock provided in the door 28 of the booth apparatus 10A is unlocked by using an account. In addition, logging in to a booth apparatus providing service provided by the management device 40 or logging in to the management device 40 may be performed by using an account for a booth apparatus.

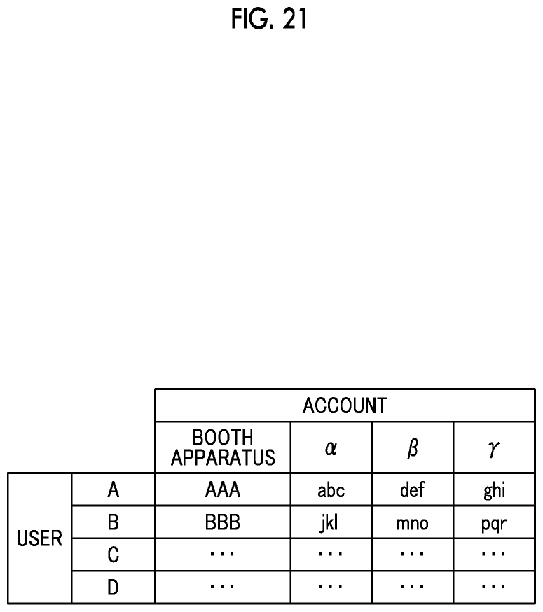

FIG. 21 shows an example of a management table for management of accounts of users. FIG. 21 shows respective accounts of users A, B, C, and D. For example, for each user, an account for a booth apparatus, an account for the α system 110, an account for the β system 112, and an account for the γ system 114 are associated with each other. For example, the management table shown in FIG. 21 is stored in the control device 30, the management device 40, or another device. Since the account for the booth apparatus and the respective accounts for the systems are associated with each other in the management table, single sign-on in which, for example, the account for the booth apparatus is used is realized. For example, in a case where a user is authenticated in the booth apparatus 10 or the booth apparatus 10A by using an account for a booth apparatus, login of the user to the α system 110, the β system 112, and the γ system 114 is finished.

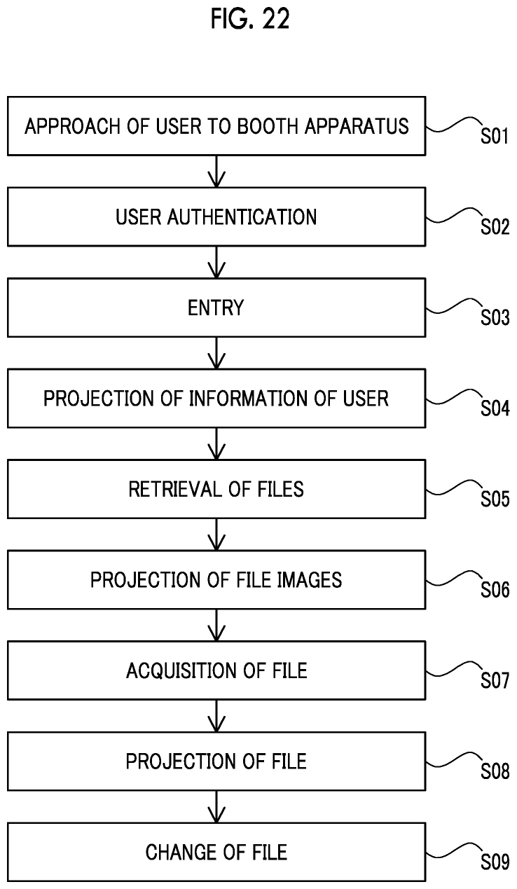

The flow of the processing according to the second exemplary embodiment will be described below with reference to FIG. 22. FIG. 22 shows a flowchart showing the flow of the processing according to the second exemplary embodiment. Here, for example, it will be assumed that a user uses the booth apparatus 10A.

First, the user approaches the booth apparatus 10A (S01). Thereafter, user authentication is performed (S02). For example, the user authentication is performed by means of an account for a booth apparatus. As described in the first exemplary embodiment, a camera provided in the booth apparatus 10A may image the user so that the user authentication is performed or authentication in which an IC card or biometric authentication may also be performed. In a case where the user authentication is successful, the electronic lock of the door 28 is unlocked. The processor 38 of the control device 30 recognizes the user authenticated through the user authentication. In a case where the user authentication is successful, the login of the user to the control device 30, the management device 40, or a service provided by the management device 40 is finished. With this login, single sign-on to the α system 110, the β system 112, and the γ system 114 is realized.

In a case where the user enters the booth apparatus 10A, entry of the user into the booth apparatus 10A is detected (S03). For example, the user is detected by a human sensor provided in the booth apparatus 10A.

The processor 38 of the control device 30 collects information about the user who has logged in and causes the projecting device 16 to project the information (S04). For example, the information about the user is a user image, other user identification information, or the like.

In addition, the processor 38 retrieves files associated with the account for a booth apparatus of the user who has logged in (S05). For example, the processor 38 retrieves, from each of the α system 110, the β system 112, and the γ system 114, the files associated with the account of the user who has logged in.

The projecting device 16 project file images (for example, icons, thumbnail images of the files, or the like) showing the files retrieved in step S05 onto a surface (at least one surface out of the first surface 18a, the second surface 20a, or the third surface 22a) in the booth apparatus 10A (S06). The file images may be generated by the processor 38 of the control device 30 or may be generated by respective devices or respective systems (for example, the α system 110, the β system 112, the γ system 114, or the like) in which the files are stored. The projecting device 16 projects a thumbnail image of each file onto a surface in the booth apparatus 10A. The processor 38 may cause the projecting device 16 to project a thumbnail image of a file stored in a terminal device (for example, the terminal device 116) used by the user who has logged in.

In a case where a plurality of file images are projected and the user selects a file to be acquired from the plurality of file images, the processor 38 acquires the selected file from a system in which the file is stored or the terminal device 116 (S07).

The projecting device 16 projects the file acquired in step S07 onto a surface in the booth apparatus 10A (S08). For example, in a case where the file is document data, the projecting device 16 projects the contents of the document data onto the surface in the booth apparatus 10A.

In a case where the user changes a file to be projected in the booth apparatus 10A, the processor 38 acquires a file in accordance with the change and the projecting device 16 projects the acquired file (S09).

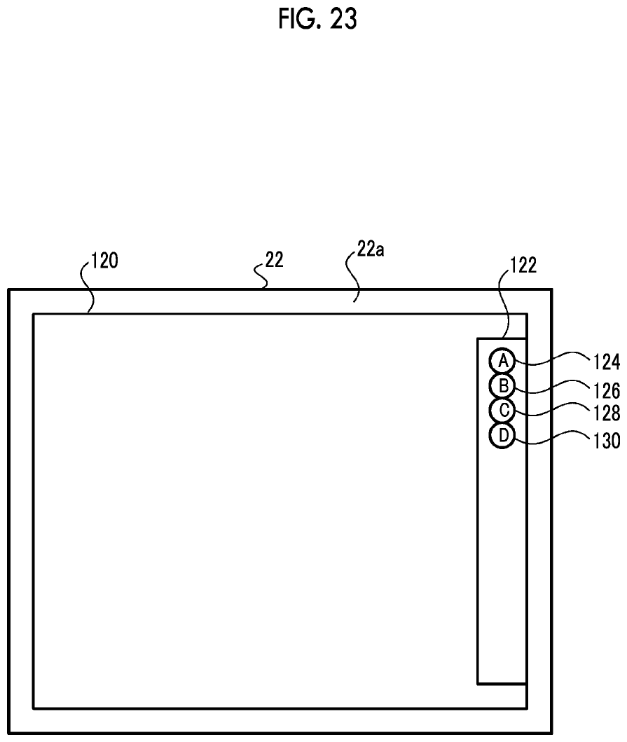

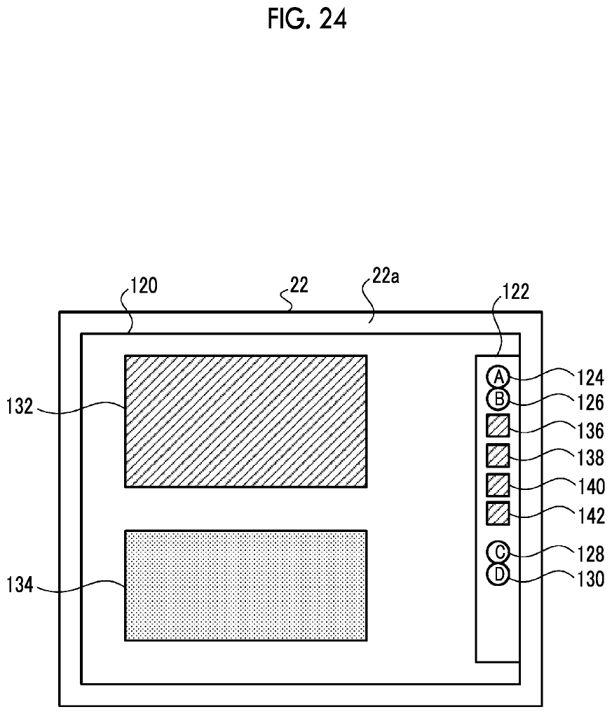

Hereinafter, an example of the way in which an user image and a file image are displayed will be described with reference to FIGS. 23 and 24. FIG. 23 and FIG. 24 are views showing the third surface 22a of the booth apparatus 10A.

Here, for example, it will be assumed that the users A, B, C, and D use the booth apparatus 10A together.

For example, the user A makes a reservation for the booth apparatus 10A. Accordingly, reservation information, which includes an account for a booth apparatus of the user A and information indicating a time for use of the booth apparatus 10A, is registered in the management device 40. The reservation information may be transmitted from the management device 40 to the control device 30 and stored in the memory 36 of the control device 30 so that the reservation for the booth apparatus 10A is managed by the control device 30.

The user A may register the users A, B, C, and D as users of the booth apparatus 10A in the management device 40 at the time of the reservation. Accordingly, respective accounts for a booth apparatus of the users A, B, C, and D are associated with each other, are included in the reservation information together with information indicating a time for use of the booth apparatus 10A, and are registered in the management device 40. In this example as well, the reservation information may be transmitted from the management device 40 to the control device 30 and stored in the memory 36 of the control device 30 so that the reservation for the booth apparatus 10A is managed by the control device 30.

User authentication is performed when the users A, B, C, and D use the booth apparatus 10A and in a case where the user authentication is successful, entry into the booth apparatus 10A is allowed. The user authentication may be performed only for the user A, or the user authentication may be performed for each of the users A, B, C, and D.

Here, for example, it will be assumed that the user authentication is performed for each of the users A, B, C, and D. In a case where the user authentication for each of the users A, B, C, and D is successful, single sign-on is realized for each of the users A, B, C, and D. Accordingly, access from the control device 30 to the α system 110, the β system 112, and the γ system 114 is allowed.

In a case where the user authentication for the users A, B, C, and D is successful, the projecting device 16 projects user images of the users A, B, C, and D onto the third surface 22a under the control of the control device 30. In FIG. 23, an entire image 120 is projected onto the third surface 22a. The entire image 120 includes a display region 122. The display region 122 is a region onto which a user image and a file image of a user of which user authentication is successful are projected.

Since the user authentication of the users A, B, C, and D is successful, a user image 124 showing the user A, a user image 126 showing the user B, a user image 128 showing the user C, and a user image 130 showing the user D are projected onto the display region 122. For example, the user images 124, 126, 128, and 130 are projected to be arranged in a line in a vertical direction. Such a display example is merely an example and a plurality of user images may be projected to form a plurality of lines in the vertical direction or may be projected to form one or more lines in a right-left direction.

Note that respective user images of the users A, B, C, and D may be projected onto the third surface 22a without user authentication for the users B, C, and D in a case where the users A, B, C, and D are registered in the management device 40 at the time of a reservation for the booth apparatus 10A and user authentication for the user A is successful.

For example, in a case where a user selects a user image from the user images 124, 126, 128, and 130, the processor 38 retrieves a file associated with an account of a user shown in the selected user image. Under the control of the control device 30, the projecting device 16 projects a file image showing the retrieved file onto the third surface 22a. For example, the processor 38 retrieves the file from the α system 110, the β system 112, and the γ system 114. The processor 38 may retrieve the file from a terminal device of a selected user. An operation of selecting a user image is realized by an operation as described in the first exemplary embodiment. For example, an operation of selecting a user image may be detected by a hand tracking sensor. It is a matter of course that a user may select a user image by operating the UI 34 included in the control device 30 or the user may select the user image by connecting a terminal device of the user to the control device 30 and operating a UI of the terminal device.

For example, in a case where the user image 126 showing the user B is selected, the processor 38 retrieves a file associated with an account of the user B from the α system 110, the β system 112, and the γ system 114. As described above, since single sign-on with respect to the α system 110, the β system 112, and the γ system 114 is realized, the processor 38 can retrieve the file associated with the account of the user B by accessing the systems. The processor 38 may retrieve the file from a terminal device of the user B. The projecting device 16 projects a file image showing the retrieved file onto the third surface 22a.

FIG. 24 shows an example of the way in which a file image is displayed. Each of file images 136, 138, 140, and 142 is an image showing a file associated with an account of the user B. For example, in a case where the user image 126 is selected in a state where the user images 124, 126, 128, and 130 are projected to be arranged in a line in this order, the processor 38 causes a space to be formed between the selected user image 126 and the user image 128 displayed below the user image 126 and causes the projecting device 16 to project the file images 136, 138, 140, and 142 such that the file images 136, 138, 140, and 142 are displayed within the space. Accordingly, the file images 136, 138, 140, and 142 and the user image 126 showing the user B are projected in association with each other.

The processor 38 may cause the projecting device 16 to project a file image of the user B which has been previously projected in the booth apparatus 10A. The processor 38 may cause the projecting device 16 to project a file image showing a file that the user B has recently used by using an account for the α system 110. The same applies to systems other than the α system 110.

For example, the file image 136 is an image showing a file stored in the α system 110 and is an image showing a file associated with an account for the α system 110 of the user B. The file image 138 is an image showing a file stored in the β system 112 and is an image showing a file associated with an account for the β system 112 of the user B. The file image 140 is an image showing a file stored in the γ system 114 and is an image showing a file associated with an account for the γ system 114 of the user B. The file image 142 is an image showing a file stored in a terminal device of the user B.

In the above-described example, the user B is an example of the first user and the file images 136, 138, 140, and 142 are examples of the images included in the first file image. For example, the account for the α system 110 of the user B is the first account and the account for the β system 112 of the user B is the second account. The file image 136 is an example of an image showing a file associated with the first account of the user B who is the first user and the file image 138 is an example of an image showing a file associated with the second account of the user B who is the first user.

In a case where a file image is selected from a plurality of file images by a user, the processor 38 acquires a file shown in the selected file image from a system or a device in which the file is stored. The processor 38 starts a program used to read or edit the file and causes the projecting device 16 to project the contents of the file. Accordingly, the contents of the file are projected onto the third surface 22a. For example, in a case where the file is document data, the contents of the document are projected onto the third surface 22a.

For example, in a case where the file image 136 is selected, the processor 38 acquires a file shown in the file image 136 from the α system 110. The projecting device 16 projects the contents of the file onto the third surface 22a.

In FIG. 24, the contents of the file are projected. For example, an image 132 is an image showing the contents of the file shown in the file image 136. In addition, an image 134 is an image showing the contents of a file shown in the file image 138.

In a case where the user image 124 showing the user A is selected in a state as shown in FIG. 24, the processor 38 retrieves a file associated with an account of the user as with retrieval of a file of the user B. The processor 38 causes a space to be formed between the user image 124 showing the user A and the user image 126 showing the user B and causes the projecting device 16 to project a file image showing the retrieved file such that the file image is projected within the space. In a case where a file image is selected, the projecting device 16 projects, onto the third surface 22a, an image showing the contents of a file shown in the selected file image. In this case, the projecting device 16 may project, onto the third surface 22a, the image showing the contents of the file together with the images 132 and 134. Accordingly, the contents of a plurality of files associated with different users are projected onto the same third surface 22a. It is a matter of course that an image showing the contents of a file associated with an account of the user A may be projected onto a surface (for example, the first surface 18a) other than the third surface 22a. The projecting device 16 may not project the images 132 and 134 onto the third surface 22a in a case where a file image showing a file associated with an account of the user A is selected.

In a case where the user image 124 showing the user A is selected, the processor 38 causes a space between the user image 126 showing the user B and the user image 128 showing the user C to be removed and causes the projecting device 16 not to project the file images 136, 138, 140, and 142. Accordingly, as a file image, only a file image associated with an account of the user A is projected onto the third surface 22a. It is a matter of course that the file images 136, 138, 140, and 142 may continue to be displayed even in a case where the user image 124 is selected. In a case where the user image 126 is selected in such a case, the space between the user image 126 and the user image 128 may be removed so that the file images 136, 138, 140, and 142 are not projected. Similar processing is performed also in a case where another user image is selected.

Note that the processor 38 may cause the projecting device 16 to project a file image showing a file associated with an account of the user A, a file image showing a file associated with an account of the user B, a file image showing a file associated with an account of the user C, and a file image showing a file associated with an account of the user D such that the file images are projected onto the display region 122 to be arranged.

For example, the projecting device 16 projects the file image showing the file associated with the account of the user A onto a space between the user image 124 and the user image 126. The projecting device 16 projects the file image showing the file associated with the account of the user B onto a region between the user image 126 and the user image 128. The projecting device 16 projects the file image showing the file associated with the account of the user C onto a region between the user image 128 and the user image 130. The projecting device 16 projects the file image showing the file associated with the account of the user D onto a region below the user image 130. In this way, a file image showing a file associated with an account of each user may be projected.

The projecting device 16 may project an image showing the contents of a file associated with a certain account of a certain user onto a certain surface and project an image showing the contents of a file associated with another account of the user onto another surface. For example, the projecting device 16 projects the image 132 showing the contents of a certain file onto the third surface 22a and projects the image 134 showing the contents of another file onto a surface (for example, the first surface 18a) other than the third surface 22a.

In addition, in a case where images showing the contents of files associated with respective accounts of a plurality of users are to be projected, the projecting device 16 may project an image showing the contents of a file associated with an account of a certain user onto a certain surface and project an image showing the contents of a file associated with an account of another user onto another surface. For example, it will be assumed that a file image showing a file associated with an account of the user A and a file image showing a file associated with an account of the user B are selected. In this case, the projecting device 16 projects an image showing the contents of the file associated with the account of the user A onto the first surface 18a and projects an image showing the contents of the file associated with the account of the user B onto the third surface 22a. Accordingly, a user can refer to the contents of each file while identifying a user associated with a file.

The configuration of the entire system according to each of the first exemplary embodiment and the second exemplary embodiment is merely an example and the processing in each of the first exemplary embodiment and the second exemplary embodiment may be realized as the entire system. That is, some or all of the functions of the control device 30 may be realized by the management device 40, a terminal device, or another device, and some or all of the functions of the management device 40 may be realized by the control device 30, a terminal device, or another device.

Similarly, in a case in which some of the functions of the control device 30 are realized by a device other than the control device 30, an information processing system may be composed of the control device 30 and the device other than the control device 30. That is, the functions of the control device 30 may be realized by a single device or by an information processing system including a plurality of devices.

Similarly, in a case where some of the functions of the management device 40 are realized by a device other than the management device 40, an information processing system may be composed of the management device 40 and the device other than the management device 40. That is, the functions of the management device 40 may be realized by a single device or by an information processing system including a plurality of devices.

Each of the functions of the control device 30 and the management device 40 is realized, for example, in cooperation with hardware and software. For example, each of the functions of the control device 30 is realized as the processor 38 of the control device 30 reads and executes a program stored in a memory. The program is stored in the memory via a recording medium, such as a CD or a DVD, or via a communication path, such as a network. For example, the processor 48 of the management device 40 reads the program stored in the memory and executes the program to realize each of the functions of the management device 40. The program is stored in the memory via a recording medium, such as a CD or a DVD, or via a communication path, such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

A booth apparatus comprising:
a space forming member that includes a first surface, a second surface, and a third surface and that forms a space surrounded by the first surface, the second surface, and the third surface;
an electronic blackboard that is provided on any of the first surface, the second surface, or the third surface in the space; and
a projecting device that projects an image onto at least one surface out of the first surface, the second surface, or the third surface on which the electronic blackboard is not provided.

(((2)))

The booth apparatus according to (((1))),
wherein the second surface is a surface that intersects the first surface beside the first surface,
the third surface is a surface that faces the first surface beside the second surface and that intersects the second surface,
the electronic blackboard is provided on the second surface, and
the projecting device projects the image onto at least one surface out of the first surface or the third surface.

(((3)))

The booth apparatus according to (((2))),
wherein the projecting device projects the image onto any of the first surface or the third surface in accordance with an attribute of an authenticated user.

(((4)))

The booth apparatus according to (((1))),
wherein the second surface is a surface that intersects the first surface beside the first surface,
the third surface is a surface that faces the first surface beside the second surface and that intersects the second surface,
the electronic blackboard is provided on the first surface,
the second surface and the third surface are connected to each other, and
the projecting device projects the image onto the second surface and the third surface.

(((5)))

The booth apparatus according to (((1))),
wherein the projecting device projects information input to the electronic blackboard onto at least one surface out of the first surface, the second surface, or the third surface on which the electronic blackboard is not provided.

(((6)))

The booth apparatus according to (((5))),
wherein the projecting device projects the information to be gradually moved from an electronic blackboard side on the at least one surface.

(((7)))

The booth apparatus according to (((6))),
wherein the projecting device projects an image showing a position of start of projection of the information on the at least one surface.

(((8)))

The booth apparatus according to (((1))),
wherein the projecting device projects the image onto two surfaces out of the first surface, the second surface, or the third surface on which the electronic blackboard is not provided,
one of the two surfaces is determined as a first projection screen and the other of the two surfaces is determined as a second projection screen, and
the projecting device projects a first image showing first information onto the first projection screen and projects a second image showing second information related to the first information onto the second projection screen.

(((9)))

The booth apparatus according to (((8))),
wherein the projecting device projects, onto the second projection screen, the second image included in the first image.

(((10)))

The booth apparatus according to (((1))),
wherein the projecting device projects, onto the at least one surface, a first image projected onto a surface of another booth apparatus.

(((11))

The booth apparatus according to (((10))),
wherein the projecting device projects, onto the at least one surface, a second image to be superimposed on the first image, the second image being captured by a camera that is provided on the surface of the other booth apparatus and that images an inside of the other booth apparatus.

(((12)))

The booth apparatus according to (((10))), further comprising:
a processor configured to:
transmit, to the other booth apparatus, an image projected onto a surface onto which the first image is not projected so that the image is projected onto a surface of the other booth apparatus.

(((13)))

The booth apparatus according to (((1))), further comprising:
a microphone,
wherein the projecting device projects, onto the at least one surface, a text string representing a voice acquired by the microphone.

(((14)))

The booth apparatus according to (((13))),
wherein the projecting device projects the text string onto a surface ahead of a person who has emitted the voice.

(((15)))

The booth apparatus according to (((14))),
wherein the projecting device projects the text string in a display style corresponding to an orientation of the person who has emitted the voice.

(((16)))

The booth apparatus according to (((1)), further comprising:
a processor configured to:
turn on the projecting device in a case where a reservation for the space is made and a person who has made the reservation is authenticated for use of the space.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A booth apparatus comprising:
a space forming member that includes a first surface, a second surface, and a third surface and that forms a space surrounded by the first surface, the second surface, and the third surface;
an electronic blackboard that is provided on any of the first surface, the second surface, or the third surface in the space; and
a projecting device that projects an image onto at least one surface out of the first surface, the second surface, or the third surface on which the electronic blackboard is not provided.

2. The booth apparatus according to claim 1,
wherein the second surface is a surface that intersects the first surface beside the first surface,
the third surface is a surface that faces the first surface beside the second surface and that intersects the second surface,
the electronic blackboard is provided on the second surface, and
the projecting device projects the image onto at least one surface out of the first surface or the third surface.

3. The booth apparatus according to claim 2,
wherein the projecting device projects the image onto any of the first surface or the third surface in accordance with an attribute of an authenticated user.

4. The booth apparatus according to claim 1,
wherein the second surface is a surface that intersects the first surface beside the first surface,
the third surface is a surface that faces the first surface beside the second surface and that intersects the second surface,
the electronic blackboard is provided on the first surface,
the second surface and the third surface are connected to each other, and
the projecting device projects the image onto the second surface and the third surface.

5. The booth apparatus according to claim 1,
wherein the projecting device projects information input to the electronic blackboard onto at least one surface out of the first surface, the second surface, or the third surface on which the electronic blackboard is not provided.

6. The booth apparatus according to claim 5,
wherein the projecting device projects the information to be gradually moved from an electronic blackboard side on the at least one surface.

7. The booth apparatus according to claim 6,
wherein the projecting device projects an image showing a position of start of projection of the information on the at least one surface.

8. The booth apparatus according to claim 1,
wherein the projecting device projects the image onto two surfaces out of the first surface, the second surface, or the third surface on which the electronic blackboard is not provided,
one of the two surfaces is determined as a first projection screen and the other of the two surfaces is determined as a second projection screen, and
the projecting device projects a first image showing first information onto the first projection screen and projects a second image showing second information related to the first information onto the second projection screen.

9. The booth apparatus according to claim 8,
wherein the projecting device projects, onto the second projection screen, the second image included in the first image.

10. The booth apparatus according to claim 1,
wherein the projecting device projects, onto the at least one surface, a first image projected onto a surface of another booth apparatus.

11. The booth apparatus according to claim 10,
wherein the projecting device projects, onto the at least one surface, a second image to be superimposed on the first image, the second image being captured by a camera that is provided on the surface of the other booth apparatus and that images an inside of the other booth apparatus.

12. The booth apparatus according to claim 10, further comprising:
a processor configured to:
transmit, to the other booth apparatus, an image projected onto a surface onto which the first image is not projected so that the image is projected onto a surface of the other booth apparatus.

13. The booth apparatus according to claim 1, further comprising:
a microphone,
wherein the projecting device projects, onto the at least one surface, a text string representing a voice acquired by the microphone.

14. The booth apparatus according to claim 13,
wherein the projecting device projects the text string onto a surface ahead of a person who has emitted the voice.

15. The booth apparatus according to claim 14,
wherein the projecting device projects the text string in a display style corresponding to an orientation of the person who has emitted the voice.

16. The booth apparatus according to claim 1, further comprising:
a processor configured to:
turn on the projecting device in a case where a reservation for the space is made and a person who has made the reservation is authenticated for use of the space.
